(19) United States
(12) Patent Application Publication
(10) Pub. No.: US 2023/0038171 A1
(43) Pub. Date: Feb. 9, 2023

(54) KITCHEN APPLIANCE, METHOD, AND SYSTEM FOR SOUS VIDE

(71) Applicant: BREVILLE PTY LIMITED, Alexandria, New South Wales (AU)

(72) Inventors: Giselle STIDSTON, Alexandria (AU); Audrey CHIU, Alexandria (AU); Tibor HEGEDIS, Alexandria (AU)

(21) Appl. No.: 17/790,631

(22) PCT Filed: Dec. 23, 2020
(86) PCT No.: PCT/AU2020/051426

§ 371 Date: Jul. 1, 2022

(30) Foreign Application Priority Data
Jan. 3, 2020 (AU) 2020900007

(51) Int. Cl. A47J 36/32; A47J 27/10; A47J 36/24

(52) U.S. Cl. CPC A47J 36/321; A47J 27/10; A47J 36/2405; A47J 2202/00

(57) ABSTRACT

A kitchen appliance, method, system and computer readable medium for sous vide cooking are disclosed. The kitchen appliance includes: a heater for heating fluid; a first temperature sensor for sensing a temperature of a food item contained in a sous vide bag within the fluid; a second temperature sensor for sensing a temperature of the fluid; and a controller, operatively connected to the heater and in communication with the temperature sensors, wherein the controller comprises a memory and a processor configured to: receive, from the first temperature sensor, one or more first temperature samples indicative of a temperature of the food item; receive, from the second temperature sensor, one or more second temperature samples indicative of a fluid temperature; control operation of the heater according to the one or more second temperature samples and a target cooking temperature; and store, in memory in a non-volatile manner, the one or more first temperature samples.

### TECHNICAL FIELD

The present invention relates to a kitchen appliance, method, system, and computer readable medium for sous vide cooking.

### BACKGROUND

Sous vide is emerging as a commonly used cooking technique in restaurants. Reduction in prices of sous vide machines has resulted in widespread acceptance across both restaurant owners and home chefs.

However, there have been concerns of health safety associated with sous vide cooking, especially in relation to bacterial contamination. For example, improper sous vide operations can encourage growth of certain bacteria such as Salmonella, Escherichia coli, and Clostridium perfringens. Due to the anaerobic conditions, together with the relatively low temperature heat treatment of sous vide cooking, an atmosphere is created where the pathogens such as Clostridium perfringens and Salmonella can multiply to dangerous levels without proper hygiene practices.

As a result, most restaurant owners and/or chefs may need to provide information to a health inspector for at least some or all articles of food cooked using sous vide. This can be in the form of logs / other legal paperwork. Whilst this helps to ensure that food cooking is safe for consumption, it can be a time-consuming task to manually record a log of each food item cooked.

### SUMMARY

It is an object of the present invention to substantially overcome or at least ameliorate one or more disadvantages of existing arrangements.

In a first aspect there is provided a kitchen appliance for sous vide cooking, including: a heater for heating a fluid; a first temperature sensor for sensing a temperature of a food item contained in a sous vide bag located within the fluid of a vessel; a second temperature sensor for sensing a temperature of the fluid; and a controller, operatively connected to the heater and in communication with the first and second temperature sensors, wherein the controller comprises of a memory and a processor configured to: receive, from the first temperature sensor, one or more first temperature samples indicative of a temperature of the food item; receive, from the second temperature sensor, one or more second temperature samples indicative of a temperature of the liquid; control operation of the heater according to the one or more second temperature samples and a target cooking temperature; and store, in memory in a non-volatile manner, the one or more first temperature samples.

In certain embodiments, the kitchen appliance further comprises: an input device, in communication with the processor, to receive user input to selectively enable a data logging mode; and an output device, in communication with the processor; wherein the processor is configured to: receive, from the input device, user input indicative of enablement of a data logging mode of the kitchen appliance; and output, via the output device, an indication that the kitchen appliance is operating in the data logging mode.

In certain embodiments, the processor is configured to output one or more temperatures based on at least some of the one or more first temperature samples and the one or more second temperature samples.

In certain embodiments, the processor is configured to output, via the output device: a current food item temperature based on at least some of the one or more first temperature samples; and a current fluid temperature based on at least some of the one or more second temperature samples.

In certain embodiments, the processor is configured to output, via the output device, the target fluid temperature.

In certain embodiments, the processor is configured to: receive, via the input device, the target fluid temperature; and record, in the memory, the target fluid temperature.

In certain embodiments, the processor is configured to: receive, via the input device, a selection of an operating user of the kitchen appliance for cooking the food item; and record, in the memory, an association between the operating user and the one or more second temperature samples.

In certain embodiments, the processor is configured to: receive, via the input device, a log name; and record, in the memory, an association between the log name and the one or more second temperature samples.

In certain embodiments, the processor is configured to: receive, via the input device, a thickness of the food item; and record, in the memory, an association between the thickness of the food item with the one or more second temperature samples.

In certain embodiments, the processor is configured to receive, from the input device, input indicative of a start of a data logging job, wherein in response to receiving the input indicative of the start of a data logging job, the one or more first temperature samples are recorded in the memory.

In certain embodiments, the processor is configured to receive, from the input device, input indicative of an end of the data logging job, wherein in response to receiving the input indicative of the end of the data logging job, the one or more first temperature samples are no longer recorded in the memory.

In certain embodiments, the processor is configured to: receive, via the input device and whilst the food item is being cooked, input indicative of a request for output of at least some of the one or more first temperature samples recorded for the food item; and retrieve, from memory, and output, via the output device, the one or more first temperature samples recorded for the food item being cooked.

In certain embodiments, the processor is configured to record, in the memory, temporal data in association with the one or more second temperature samples.

In certain embodiments, the processor is configured to record in memory a timestamp associated at least one of each first temperature sample.

In certain embodiments, the memory has stored therein a plurality of data log records, each data log record including one or more first temperature samples recorded for cooking a respective food item, wherein the processor is configured to: transfer at least some of the plurality of data log records to a computing device; record, in memory, a sent flag associated with each data log record from the plurality of data log records which were transferred to the computing device; and in response to the memory having less than a threshold amount of free capacity, delete, in chronological order, at least some of the plurality of data log records having an associated sent flag.

In certain embodiments, the first temperature sensor is in communication with the processor via a wired medium.

In certain embodiments, the first temperature sensor is received with a sealable port of the sous vide bag.

In certain embodiments, the kitchen appliance is one of: a thermal immersion circulator; an oven; or a heating blender.

In a second aspect there is provided a system including: the kitchen appliance of the first aspect; and a mobile communication device configured to receive the one or more first temperature samples recorded in the memory of the controller.

In certain embodiments, the kitchen appliance is configured to wirelessly transfer the one or more first temperature samples to the mobile communication device.

In certain embodiments, the kitchen appliance is configured to transfer, via the mobile communication device, the one or more first temperature samples to a cloud server processing system.

In a third aspect, there is provided a method performed by a kitchen appliance, the kitchen appliance including a heater for heating a fluid, a first temperature sensor in physical contact with a food item contained in a sous vide bag located within the fluid, a second temperature sensor for sensing the temperature of the fluid, and a controller, operatively connected to the heater and in communication with the first and second temperature sensors, wherein the controller comprises of a memory and a processor, wherein the method includes: receiving, by the processor from the first temperature sensor, one or more first temperature samples indicative of a temperature of the food item; receiving, by the processor from the second temperature sensor, one or more second temperature samples indicative of a temperature of the liquid; controlling, by the processor, operation of the heater according to the one or more second temperature samples and a target cooking temperature; and storing, by the processor in memory in a non-volatile manner, the one or more first temperature samples.

In certain embodiments, the kitchen appliance further comprises an input device, in communication with the processor, to receive user input to selectively enable a data logging mode, and an output device, in communication with the processor, wherein the method includes: receiving, by the processor from the input device, user input indicative of enablement of a data logging mode of the kitchen appliance; and outputting, by the processor via the output device, an indication that the kitchen appliance is operating in the data logging mode.

In certain embodiments, the method includes outputting, by the processor, one or more temperatures based on at least some of the one or more first temperature samples and the one or more second temperature samples.

In certain embodiments, the method includes outputting, by the processor via the output device: a current food item temperature based on at least some of the one or more first temperature samples; and a current fluid temperature based on at least some of the one or more second temperature samples.

In certain embodiments, the method includes the processor outputting, via the output device, the target fluid temperature.

In certain embodiments, the method includes: receiving, by the processor via the input device, the target fluid temperature; and recording, by the processor in the memory, the target fluid temperature.

In certain embodiments, the method includes: receiving, by the processor via the input device, a selection of an operating user of the kitchen appliance for cooking the food item; and recording, by the processor in the memory, an association between the operating user and the one or more second temperature samples.

In certain embodiments, the method includes: receiving, by the processor via the input device, a log name; and recording, by the processor in the memory, an association between the log name and the one or more second temperature samples.

In certain embodiments, the method includes: receiving, by the processor via the input device, a thickness of the food item; and recording, by the processor in the memory, an association between the thickness of the food item with the one or more second temperature samples.

In certain embodiments, the method includes receiving, by the processor from the input device, input indicative of a start of a data logging job, wherein in response to receiving the input indicative of the start of a data logging job, the one or more first temperature samples are recorded in the memory.

In certain embodiments, the method includes receiving, by the processor from the input device, input indicative of an end of the data logging job, wherein in response to receiving the input indicative of the end of the data logging job, the one or more first temperature samples are no longer recorded in the memory.

In certain embodiments, the method includes: receiving, by the processor via the input device and whilst the food item is being cooked, input indicative of a request for output of at least some of the one or more first temperature samples recorded for the food item; and retrieving, by the processor from memory, and outputting, by the processor via the output device, the one or more first temperature samples recorded for the food item being cooked.

In certain embodiments, the method includes recording, by the processor in the memory, temporal data in association with the one or more second temperature samples.

In certain embodiments, the method includes recording by the processor in memory a timestamp associated each first temperature sample.

In certain embodiments, the memory has stored therein a plurality of data log records, each data log record including one or more first temperature samples recorded for cooking a respective food item, wherein the method includes transferring, by the processor, at least some of the plurality of data log records to a computing device; recording, by the processor in the memory, a sent flag associated with each data log record from the plurality of data log records which were transferred to the computing device; and in response to the memory having less than a threshold amount of free capacity, deleting, in chronological order, at least some of the plurality of data log records having an associated sent flag.

In certain embodiments, the method includes communicating between the first temperature sensor and the processor via a wired medium.

In certain embodiments, the method includes transferring, by the processor to a mobile communication device, the one or more first temperature samples stored in memory of the controller.

In certain embodiments, the method includes wirelessly transferring, by the processor to the mobile communication device, the one or more first temperature samples.

In certain embodiments, the method includes transferring, by the processor via the mobile communication device, the one or more first temperature samples to a cloud server processing system.

In certain embodiments, the method includes placing the first temperature sensor in physical contact with the food item via a sealable port of the sous vide bag.

In certain embodiments, the kitchen appliance is one of: a thermal immersion circulator; an oven; or a heating blender.

In another aspect there is provided one or more computer readable mediums have stored therein or thereon executable instructions, wherein execution of the executable instructions by one or more processors of a kitchen appliance cause the kitchen appliance to perform the method of the second aspect.

Other aspects and embodiments will be appreciated throughout the description of preferred embodiments.

### BRIEF DESCRIPTION OF THE FIGURES

Example embodiments should become apparent from the following description, which is given by way of example only, of at least one preferred but non-limiting embodiment, described in connection with the accompanying figures.

FIG. 1A is a functional block diagram representing an example of a kitchen appliance.

FIG. 1B is a functional block diagram representing an example system including the kitchen appliance of FIG. 1A.

FIG. 2 is a system diagram representing an example system including a kitchen appliance.

FIG. 3 is a perspective view of an example of a kitchen appliance in the form of a thermal immersion circulator appliance.

FIG. 4 is a flowchart representing an example method performed by the kitchen appliance of FIG. 1A.

FIG. 5 is a flowchart representing a further example method performed by the kitchen appliance of FIG. 1A.

FIG. 6 is an example of a first graphical user interface displayed by an output device of the kitchen appliance of FIG. 1A.

FIG. 7 is an example of a second graphical user interface displayed by the output device of the kitchen appliance of FIG. 1A.

FIG. 8 is an example of a third graphical user interface displayed by the output device of the kitchen appliance of FIG. 1A.

FIG. 9 is an example of a fourth graphical user interface displayed by the output device of the kitchen appliance of FIG. 1A.

FIG. 10 is an example of a fifth graphical user interface displayed by the output device of the kitchen appliance of FIG. 1A.

FIG. 11 is an example of a sixth graphical user interface displayed by the output device of the kitchen appliance of FIG. 1A.

FIG. 12 is an example of a seventh graphical user interface displayed by the output device of the kitchen appliance of FIG. 1A.

### DESCRIPTION OF THE PREFERRED EMBODIMENTS

Where reference is made in any one or more of the accompanying drawings to steps and/or features, which have the same reference numerals, those steps and/or features have for the purposes of this description the same function(s) or operation(s), unless the contrary intention appears.

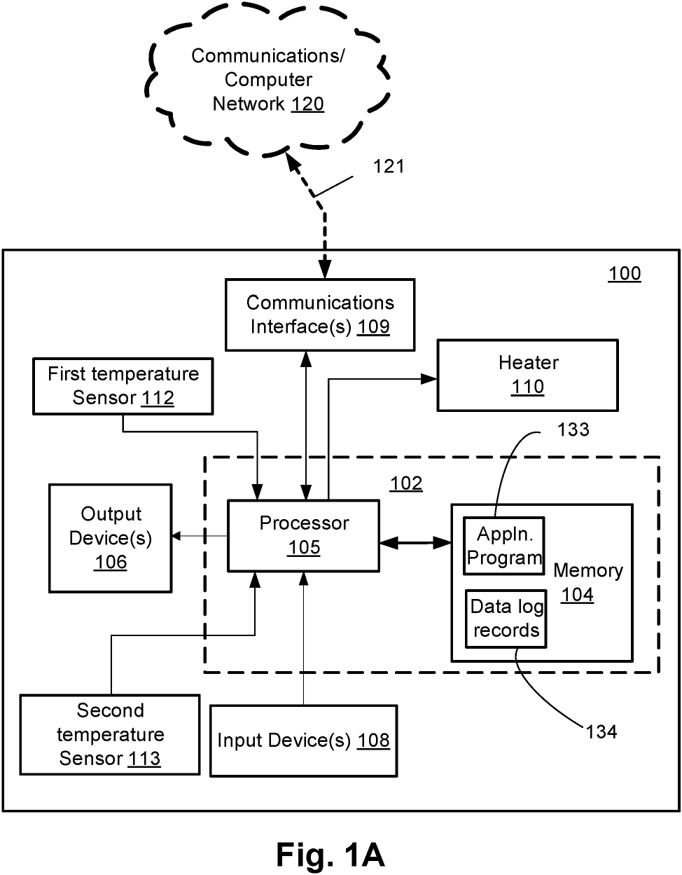

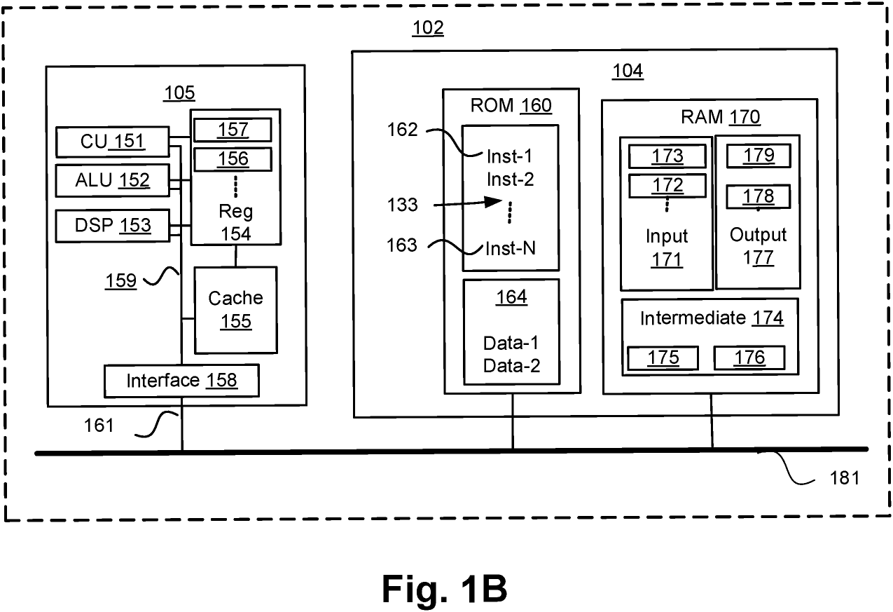

FIGS. 1A and 1B collectively form a more detailed schematic block diagram of a kitchen appliance 100 for sous vide cooking. The kitchen appliance 100 includes a heater 110, a first temperature sensor 112, a second temperature sensor 113 and a controller 102, operatively connected to the heater 110 and in communication with the first and second temperature sensors 112, 113. The heater 110 is configured to heat a fluid contained in a vessel (not shown). The first temperature sensor 112 is configured to sense a temperature of a food item (not shown) contained in a sous vide bag (not shown) located within the fluid of the vessel. The second temperature sensor 113 is configured to sense a temperature of the fluid. The controller 102 is configured to receive one or more first temperature samples and one or more second temperature samples received from the first and second temperature sensors 112, 113 respectively, wherein the one or more first temperature samples are recorded in a non-volatile manner by the controller 102. The controller 102 is configured to control operation of the heater 110 based at least partially upon the one or more second temperature samples and a target temperature.

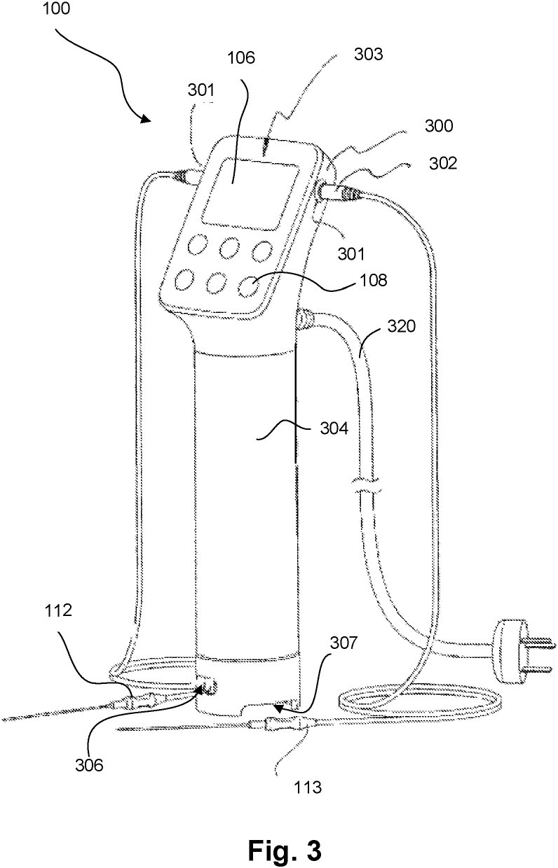

As shown in FIG. 1A, the kitchen appliance 100 includes the controller 102 which is in electrical communication with the heater 110. Furthermore, the controller 102 is in electrical communication with the first and second temperature sensors 112, 113. Additionally, the kitchen appliance 100 includes at least one output device 106 and at least one input device 108. The input and output device 108, 106 may be provided in an integrated device in the form of a touch screen interface. However, the input and output device 108, 106 can be provided in a non-integrated form as shown in FIG. 3.

In the present example, the controller 102 comprises a memory 104 and a processing unit (or processor) 105 which is bi-directionally coupled to the memory 104. The memory 104 may be formed from non-volatile semiconductor read only memory (ROM) 160 and semiconductor random access memory (RAM) 170, as shown in FIG. 1B. The RAM 170 may be volatile, non-volatile or a combination of volatile and non-volatile memory. Whilst the controller 102 is described hereinafter as having the processor 105 and memory 104, the controller 102 could also be implemented by various other types of controls, for example, electrical circuits comprising a number of electrical components (e.g., resistors, inductors, capacitors, switches).

The output device 106 presents information (e.g., logged data) to a user in accordance with signals received from the controller 102. Examples of output device 106 include display devices, for example, a liquid crystal display (LCD) panel, and sound making elements.

The input device 108 receives user input from a user. Through manipulation of the input device 108, a user can provide various selections to configure data logging functionality of the kitchen appliance 100 as well as configure cooking operation by the kitchen appliance 100 as will be described in various examples below. Examples of the input device 108 include touch sensitive panel physically associated with a display device to collectively form a touch-screen. Such a touch-screen may thus operate as one form of graphical user interface (GUI). Other forms of input device 108 may also be used, such as press buttons, dials or rotary knobs used together with the display.

The kitchen appliance 100 also has a communications interface 109 to permit communication, preferably wireless communication, with one or more computers 210, 220 (e.g., a mobile phone, tablet, laptop, server processing system) via communications network 120 using a connection 121. The kitchen appliance 100 is configured to transfer logged data to the one or more computers 210, 220 via the connection 121. The connection 121 may be wired or wireless. For example, the connection 121 may use radio frequency spectrum or optical spectrum. Furthermore, examples of wireless connection include protocols such as Bluetooth or standards of the IEEE 802 family (e.g., Wi-Fi IEEE 802.11; Zigbee IEEE 802.15.4), Infrared Data Association (IrDa), LoRa, and the like. An example of a wired connection which may be used includes Ethernet.

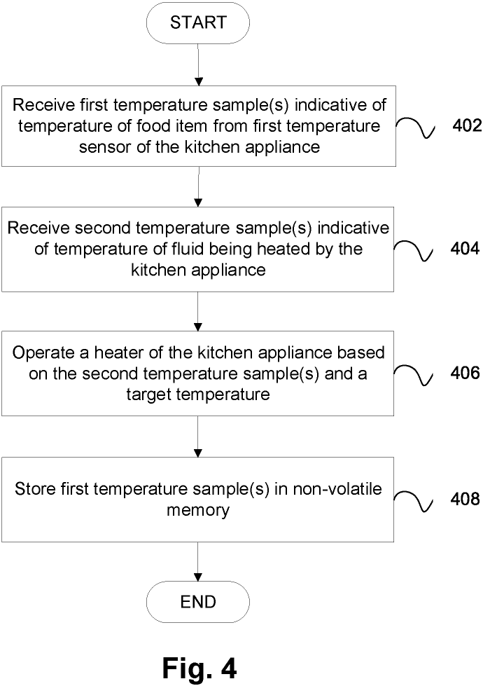

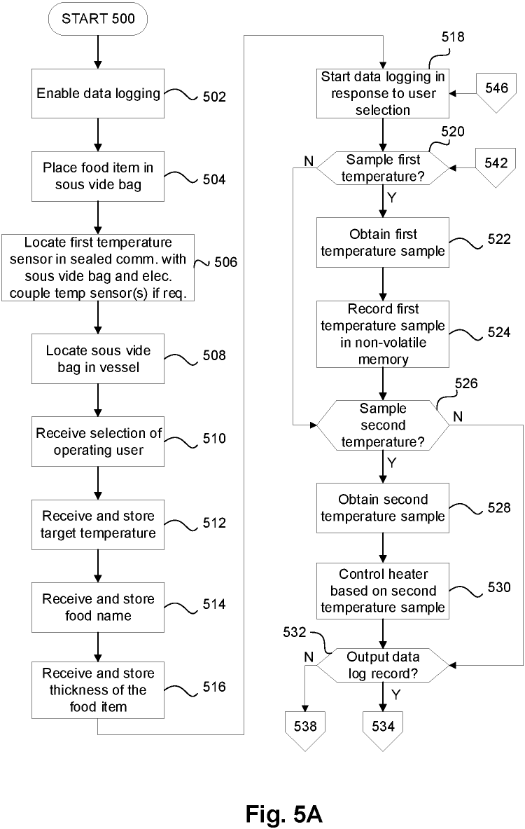

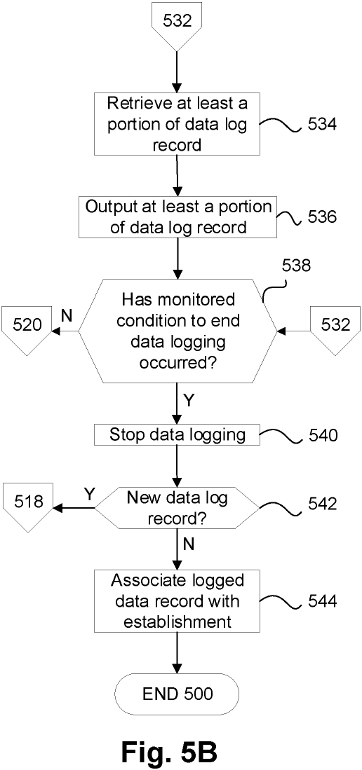

The methods described hereinafter may be implemented using the controller 102, where the processes described herein may be implemented as one or more software application programs 133 executable within the controller 102. In particular, with reference to FIGS. 4 and 5, at least some of the steps of the described methods are embodied as executable instructions of the software 133 that are executed by the controller 102. The software instructions may be formed as one or more code modules, each for performing one or more particular tasks. The software may also be divided into two separate parts, in which a first part and the corresponding code modules perform the described methods and a second part and the corresponding code modules manage a user interface between the first part and the user.

The software 133 of the controller 102 is typically stored in the non-volatile ROM 160 of the memory 104. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

FIG. 1B illustrates in detail the controller 102 comprising the processor 105 for executing the application programs 133 and the memory 104. The memory 104 comprises read only memory (ROM) 160 and random access memory (RAM) 170. The processor 105 is able to execute the application programs 133 stored in one or both of the connected memories 160 and 170. When the kitchen appliance 100 is initially powered up, a system program resident in the ROM 160 is executed. The application program permanently stored in the ROM 160 is sometimes referred to as “firmware”. Execution of the firmware by the processor 105 may fulfil various functions, including processor 105 management, memory 104 management, device management, storage management and user interface.

The processor 105 typically includes a number of functional modules including a control unit (CU) 151, an arithmetic logic unit (ALU) 152, a digital signal processor (DSP) 153 and a local or internal memory 104 comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the kitchen appliance 100. Typically, the application program 133 waits for events and subsequently executes the block of code associated with that event. Events may be triggered in response to input from a user, via the input device 108 of FIG. 1A, as detected by the processor 105. Events may also be triggered in response to other sensors and interfaces in the kitchen appliance 100.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory 104 locations in locations 175, 176 of the RAM 170. Alternatively, some intermediate variables may only exist in the registers 154 of the processor 105.

The execution of a sequence of instructions can be achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory 104 address indexed by the program counter is loaded into the control unit 151. The instruction thus loaded controls the subsequent operation of the processor 105, causing for example, data to be loaded from ROM memory 160 into processor 105 registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133 and is performed by repeated execution of a fetch-execute cycle in the processor 105 or similar programmatic operation of other independent processor 105 blocks in the kitchen appliance 100.

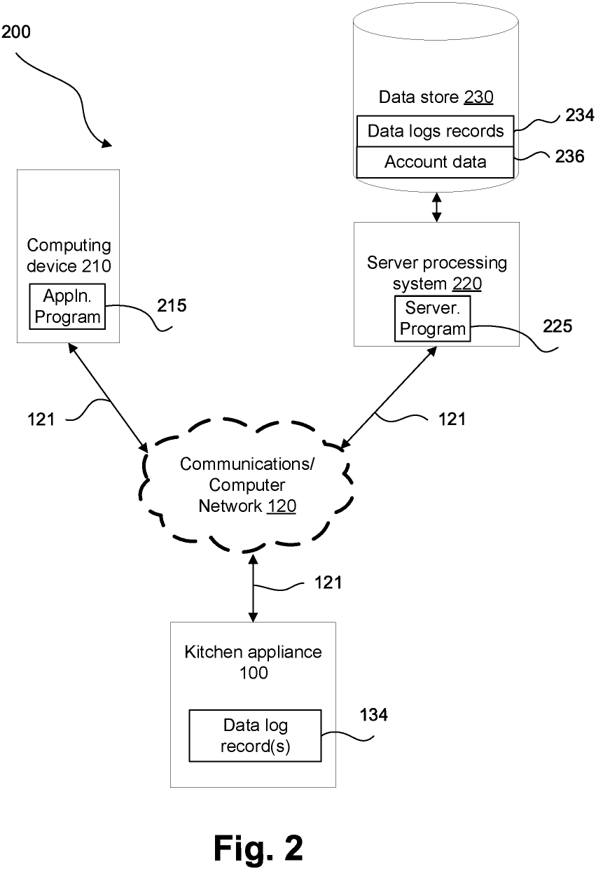

Referring to FIG. 2 there is shown a system 200 including the kitchen appliance 100 in communication with one or more computing devices 210, 220. In one form, the kitchen appliance 100 is in communication with the one or more computing devices 210, 220 via the computer network 120. In one form, the system 200 can include a personal computing device 210 such as a mobile communication device, like a smart phone, tablet, laptop or the like. The computing device 210 can have stored in memory an application program 215. In an additional or alternate form, the system 100 can include a server processing system 220 such as a cloud computing system which includes a data store 230. The kitchen appliance 100 can transfer one or more data log records 134 to the server processing system 220 either directly via the computer network 120 or indirectly via the computing device 210 under control of the application program 215. Upon receiving the data log record from the kitchen appliance 100, the server processing system 220 is under control by an executable server program 225 to record the data log record 234 in the data store 230. The data store 230 can have stored therein one or more data log records 234 for one or more kitchen appliances 100 used for sous vide cooking. Whilst the system 200 is depicted as including only a single kitchen appliance 100, it is possible that the system 200 can include a plurality of kitchen appliances 100, wherein the server processing system 220 stores a plurality of data log records 234 in the data store 230 for a plurality of kitchen appliances 100. In this instance, in addition to the data store 230 storing a plurality of data log records 234, the data store 230 also stores account data 236 indicative of one or more accounts associated with the one or more kitchen appliances 100. Each establishment (e.g. a restaurant) that operates a kitchen appliance 100 may setup an account with the server processing system 220, wherein account data 236 for each account is stored in the data store 230. It will also be appreciated that the system 100 can include a plurality of computing devices 210 for forwarding the data log records 134 for storage in the data store 230.

Referring to FIG. 3 there is shown a perspective view of an example of the kitchen appliance 100 provided in the form of a thermal immersion circulator appliance for sous vide cooking. The kitchen appliance 100 is configured to be immersed in a vessel containing fluid such as a fluid like water. The kitchen appliance 100 includes a housing 304 having a liquid flow path extending there within between an inlet 307 to an outlet 306 of the housing 304, rotatably driven vanes (not shown) associated with the fluid flow path to cause liquid to flow from the inlet 307 to the outlet 306, a motor (not shown) drivingly connected to the vanes to cause rotation thereof, a heater 110 operatively associated with the fluid flow path to heat the liquid passing there along, as well as a controller 102 for controlling the heating of the heater 110. The kitchen appliance 100 includes a head portion 303 having the input device 108 and output device 106. The kitchen appliance 100 of FIG. 3 is more fully disclosed in International Patent Application PCT/AU2018/000156 which is herein incorporated by reference in its entirety. It will be appreciated that the kitchen appliance 100 may be provided in a form having an integrated vessel or reservoir as disclosed in International Patent Application PCT/AU2013/000841 which is herein incorporated by reference in its entirety.

As shown in FIG. 3, the first temperature sensor 112 and second temperature sensor 113 are in electrical communication with the processor 105 via a wired medium. As shown in FIG. 3, the first and second temperature sensors 112, 113 may each include a connector 302 which can be releasably coupled to a respective electrical port 301 for electrical communication with the controller 102. In one variation, the second temperature sensor 113 can be located within the housing 304 to sense fluid flowing along the fluid flow path. In this variation, the second temperature sensor is not removable and cannot be uncoupled from being in electrical connection with the processor 105.

Other types of kitchen appliances 100 may be used for sous vide cooking. In particular, the kitchen appliance 100 may be provided in the form of an oven. In this example, the fluid is air rather than liquid which is the case with a thermal immersion circulator appliance. In another example, the kitchen appliance may be provided in the form of a heating blender.

Referring to FIG. 4 there is shown a flowchart representing an example method 400 of operation by the kitchen appliance 100.

At step 402, the method 400 includes receiving, by the processor 105 from the first temperature sensor 112, one or more first temperature samples indicative of a temperature of the food item.

At step 404, the method 400 includes receiving, by the processor 105 from the second temperature sensor 113, one or more second temperature samples indicative of a temperature of the fluid.

At step 406, the method 400 includes controlling, by the processor 105, operation of the heater 110 according to the one or more second temperature samples and a target cooking temperature.

At step 408, the method includes storing, by the processor 105 in memory 104 in a non-volatile manner, the one or more first temperature samples.

As the first temperature samples are automatically stored in the memory 104 of the controller 102, it is possible to provide the stored first temperature samples to a regulatory authority to satisfy regulatory requirements. It will be appreciated from the above method 400 that a number of the steps can be performed in various orders.

Referring to FIG. 5 there is shown a more detailed flowchart representing a further example method 500 of cooking a food item using the kitchen appliance 100 of FIG. 1A.

At step 502, the method 500 includes the user inputting a selection to enable a data logging mode of the kitchen appliance 100. As shown in the graphical user interface 600 of FIG. 6, the user can interact with the input device 108 to enter a settings menu for the kitchen appliance 100 and select a graphical user interface element such as a soft switch 610 to indicate enablement of data logging functionality for the kitchen appliance 100. If graphical user switch 610 is disabled, the kitchen appliance 100 can operate without performing data logging.

At step 504, the method 500 includes placing the food item in a sous vide bag and sealing the bag. The sous vide bag is preferably vacuum sealed.

At step 506, the method 500 includes locating the first temperature sensor 112 in sealed communication with the sous vide bag via a sealable port or tape and coupling the first temperature sensor 112 to the processor 105 if uncoupled. The first temperature sensors may be releasably coupled to a port 301 so as to be electrically coupled to the processor 105.

At step 508, the method 500 includes locating the sealed sous vide bag, together with the first temperature sensor, in the vessel containing the fluid to be heated by the kitchen appliance 100. As discussed earlier, the vessel may be separate to the kitchen appliance 100, as described in relation to FIG. 3, or may be integrated with the kitchen appliance 100.

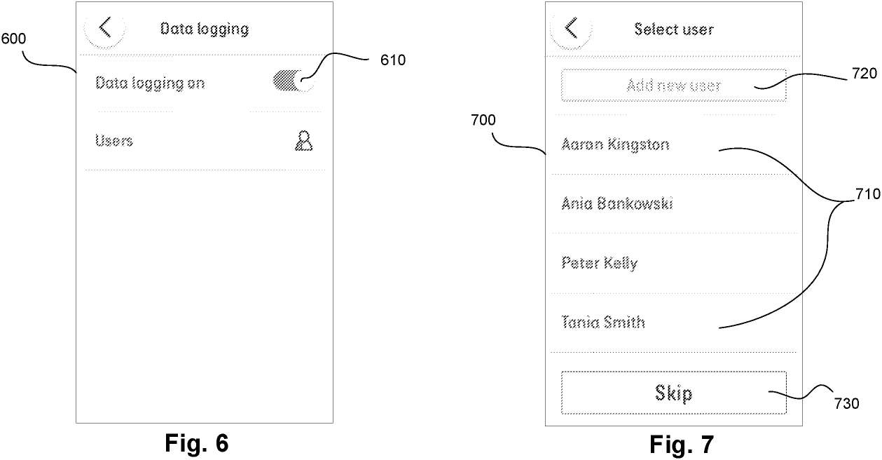

At step 510, the method 500 includes selecting an operating user or adding a new user as the operating user for cooking the food item. In one form, as shown in the graphical user interface 700 of FIG. 7, the processor 105 retrieves from the memory 104 a list 710 of all user registered to use the kitchen appliance 100, wherein the list of users 710 is presented by the output device 106 to allow user selection of one of the users from the list 710. The processor 105 also presents a graphical user element 720, such as a soft button, to allow the user to store a new user in memory 104 of the kitchen appliance 100. Upon selection, the user can define a user name using the input device 108, wherein the newly defined user name is stored in memory 104 of the kitchen appliance 100. The newly defined user can then be presented as part of the user list 710, wherein the new user can be selected from the user list 710 using the input device 108 to define the operating user of the kitchen appliance 100 which is stored in the memory 104. As shown in FIG. 7, the user can avoid selecting an operating user by selecting a graphical user element 730 such as a skip soft button.

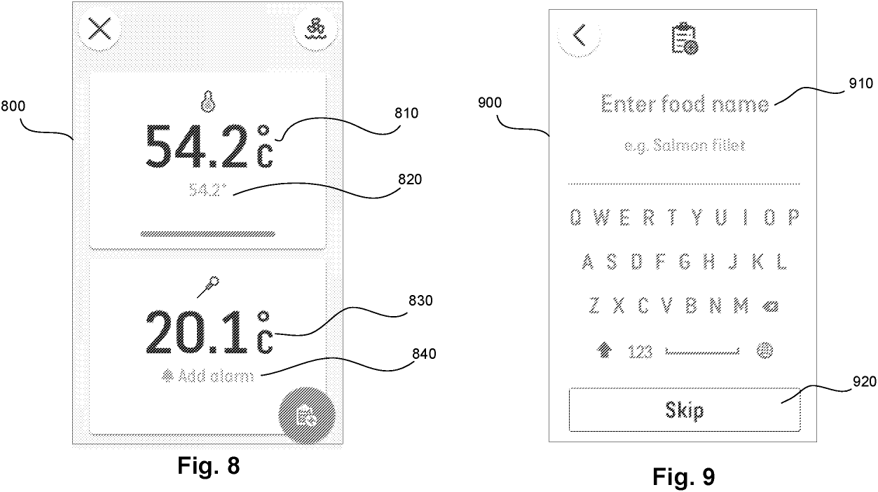

At step 512, the method 500 includes the user inputting a target temperature 820 (as best seen in FIG. 8) for the cooking the food item. For example, as shown in the graphical user interface 800 of FIG. 8, the user may input a number defining the target temperature 820 using the input device 108. Alternatively, the user may select a type of food from a list retrieved from a look-up table stored memory 104 and presented by the processor 105 via the output device 106, wherein based on the user selection from the input device 108, the processor 105 may query a lookup table based on the user selection to determine the target temperature 820 for the type of food item to be cooked. As shown by the graphical user interface 800 of FIG. 8, the processor 105 is configured to output a current first and second temperature 810, 830 based on obtaining first and second temperature samples from the first and second temperature sensors 112, 113. If either the first or second temperature sensors 112, 113 have not been electrically connected to the controller 102 of the kitchen appliance 100, no temperature value will be displayed in the graphical user interface 800. In one form an error may display to alert the user that the first and/or second temperature sensor 113 has not been coupled to the kitchen appliance 100. The graphical user interface 800 can provide a graphical user element such as a soft button to select whether an alarm should be output when the food temperature is equal to, or substantially equal to, the target temperature. In one form, as discussed above, the second temperature sensor may be integrated with the kitchen appliance rather than removably coupled thereto. In this arrangement, an error will only be displayed if the first temperature sensor 113 has not been coupled to the kitchen appliance 100 and the kitchen appliance is operating in the data logging mode.

At step 514, the method 500 includes the user inputting a log name 910. In one form, the data log name may be the name of the food item being cooked. For example, as shown in graphical user interface 900 of FIG. 9, the log name could be input via the input device 108 as “Salmon fillet” which is stored in memory 104 such that the logged data is stored in association with the log name. As shown in FIG. 9, the graphical user interface 900 can include a ‘skip’ graphical user interface element to skip defining a log name.

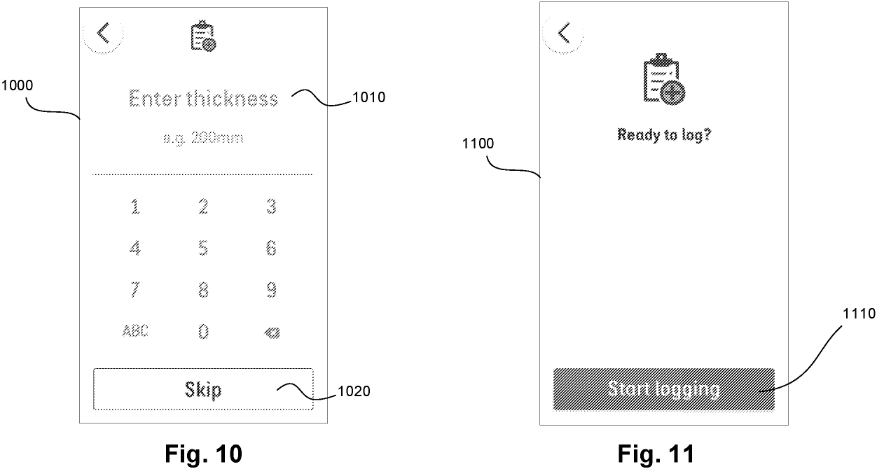

At step 516, the method 500 includes the user inputting a thickness of the food item being cooked. For example, as shown in graphical user interface 1000 of FIG. 10, the user could input via the input device 108 a thickness of the food item to be cooked such as “200 mm”, wherein the thickness is stored in memory 104. As shown in FIG. 10, the graphical user interface 1000 can include a graphical user interface element 1110 which can be selected to skip defining a thickness of the food item.

If the first temperature sensor 112 is in electrical communication with the controller 102 of the kitchen appliance 100, a soft button is presented via the output device 106 indicating that upon user selection a data log record is created and stored in memory 104 for the current cooking job. At step 518, the method 500 includes the user inputting an indication to start data logging for cooking the food item. The selection of data logging may also dual as input to start heating of the fluid in the vessel if this has not already started. In particular, as shown in graphical user interface 1100 of FIG. 11, the graphical user interface 1100 can include a graphical user interface element 1110, such as a soft button, which the user can select, wherein in response to selection of the soft button, the data log record in created in memory 104 and the controller 102 begins to sample temperatures from the first and second temperature sensor 113 for non-volatile recordal in the memory 104. The data log record for the food item being cooked can include the operating user, the target temperature, the log name, and/or thickness of the food item, in addition to the one or more temperature samples recorded as discussed further herein. In addition, the processor can be configured to record a start time of the data logging process as part of the data log record. Upon inputting an indication to start data logging, a graphical interface element of the output device 106 is displayed to indicate that active data logging is in progress.

At step 520, the method 500 includes determining if a first temperature sample of the food item is required. If the determination to step 520 is yes, the method proceeds to step 522. If the determination to step 520 is no, the method proceeds to step 526. In one form, the controller 102 uses a timer interrupt which dictates the frequency of that the temperature of the food item is sampled.

At step 522, the method 500 includes the controller 102 obtaining a first temperature sample.

At step 524, the method includes recording the first temperature sample in the memory 104 for the data log record. Temporal data such as a timestamp can be stored in association with the first temperature sample indicative of the time which the first temperature sample was obtained.

At step 526, the method 500 includes determining if a second temperature sample of the fluid is due to be measured. In response to no sample needing to be obtained, the method proceeds to step 532. In response to a sample being required, the method proceeds to step 528. In one form, the controller 102 uses a timer interrupt to dictate the frequency of that the temperature of the fluid is sampled.

At step 528, the method 500 includes the controller 102 obtaining a second temperature sample from the second temperature sensor 113 indicative of the temperature of the fluid. In an optional form, the controller 102 may record the second temperature in a non-volatile manner in the memory 104 of the kitchen appliance 100. Temporal data may also be recorded by the controller 102, such as a timestamp, indicative of the point in time which the second temperature sample was obtained.

At step 530, the method 500 includes the controller 102 controlling the operation of the heater 110. In particular, the controller 102 may include or be operatively coupled to a PID (Proportional-Integral-Derivative) controller which uses the currently obtained second temperature sample and one or more previously obtained second temperature samples to control operation of the heater 110. It will be appreciated by those skilled in the art that other control algorithms can be used by the controller 102. The method then proceeds to step 532.

At step 532, the method 500 includes the processor determining if a request has been received via the input device 108 whilst the food item is being cooked, to output at least some of the one or more first temperature samples recorded for the food item. If the determination to step 534 is yes, the method proceeds to step 530. If the determination to step 532 is no, the method also proceeds to step 538.

At step 534, the method 500 includes the processor 105 retrieving from memory 104 at least some of the current data log record 134 including at least some of the first temperature samples stored in the memory 104 for the current cooking job. For example, only a portion of the data log record (e.g. a predefined number of samples) may be retrieved from memory. For example, the log name, operating username, most recently recorded food item temperature, and temporal data associated with the most recently recorded food item temperature may be retrieved from memory.

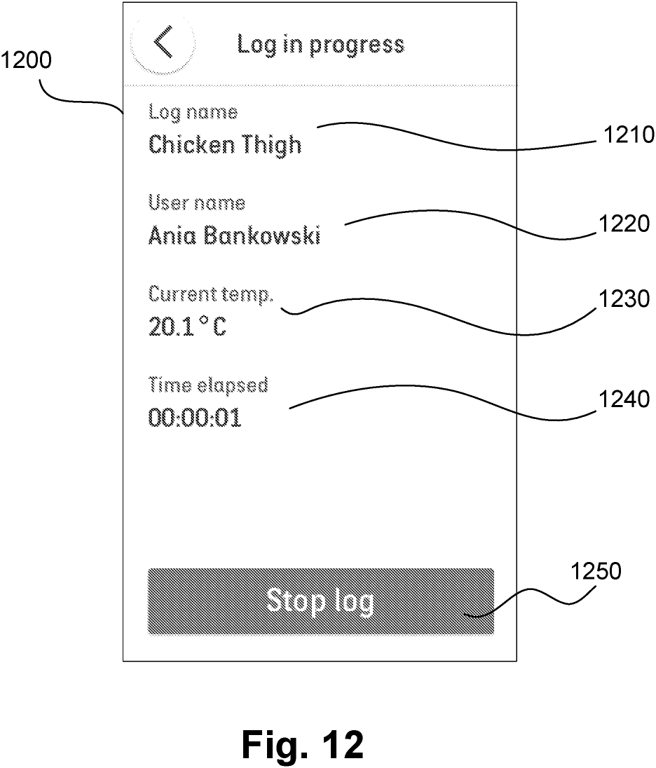

At step 536, the method 500 includes the processor 105 controlling the output device 106 to output the retrieved portion of the data log record. For example, as shown in graphical user interface 1200 of FIG. 12, the portion of the data log record which is output can include the log name, operating username, most recently recorded food item temperature, and time elapsed which is calculated by the controller by determining the temporal difference between a current time and the start time of the data log record.

At step 538, the method 500 includes the controller 102 determining whether a monitored condition to end the data logging has occurred. In one form, the monitored end condition may be the elapsing of a data logging time period which can be calculated by the processor as discussed above or input by the user using the input device 108. In an additional or alternate form, the monitored end condition may be the current food item temperature being equal to, or substantially equal to, the target temperature. In another form, this step involves determining if the user has input, via the input device 108, an indication of the data logging process to stop. In particular, as shown in the graphical user interface 1200 of FIG. 12, the user can stop the data logging by selecting a graphical user interface element 1250, such as a soft button. If the monitored end condition has occurred, the method proceeds to 540. If the determination to step 538 is no, the method 500 proceeds back to step 520 such that the temperature sampling continues to be performed as part of a data log loop until the monitored end condition has been detected. In one form, the stopping of the data logging process can also dual as an indication that the sous vide cooking process should stop. In response to selection of the stopping of the data logging process, the controller 102 of the kitchen appliance 100 stops heating the fluid via the heater 110.

At step 540, the method 500 includes the controller 102 stopping the recording temperature samples in the memory 104. In one form, the controller 102 can output a graphical notification to the output device 106 indicative of the stopped data logging. Additionally or alternatively, an audio notification may be output by a speaker or the like which is in electrical communication with the controller 102. Additionally or alternatively, a push notification may be sent to one or more computing devices which the kitchen appliance 100 is able to communicate therewith via the communication interface. For example, in the event that the kitchen appliance 100 is paired with and able to communicate with a mobile communication device 210 of the operating user via Bluetooth protocol, a notification is sent to the mobile communication device 210 indicating that the data log has been stopped. The method then proceeds to step 542.

At step 542, the method 500 includes the controller 102 controlling the output device 106 to present a graphical user interface including a selectable interface element to allow the user to create a new data log for a new food item. In the event that another food item is to be cooked and data logged, a further data log record is created in the memory 104 and the method 500 proceeds back to step 518 to begin sampling and recording the temperature of the first and second temperature sensor 113 in memory 104 for the further data log record. In one optional form, the user may be required to enter other details which were previously entered for the earlier data log record such as the log name and the thickness of the food item. If no further data log is to be recorded, the method proceeds to step 544.

At step 544, the method 500 includes the controller 102 associating the data log record 134 with an establishment which cooked the food. In one form, the kitchen appliance 100 receives input data indicative of the establishment via the input device 108, wherein input data indicative of the establishment is recorded and associated in memory 104 with the data log record. Alternatively, the input indicative of the establishment can be associated with the data log record based on data received by/from a computing device 215 in communication with the kitchen appliance 100, such as a mobile communication device. The input data indicative of the establishment can be indicative of various establishment parameters such as the establishment name and location of the establishment.

Additionally or alternatively, the method 500 includes associating the logged data with an establishment by attempting to transfer the logged data record 134 to a computing device 220 which has stored in a data store 230 establishment details in account data 236 which are inherited by association with the data log record 134. For example, the controller 102 may attempt to transfer the data log record 134 to a remote server processing system 220 which executes a computer program 225. The kitchen appliance 100 may provide credentials (e.g. username, password) to access the account data 236 stored in the data store 230 and managed by the remote server processing system 220. The data log record 134 can then be transferred to the remote server processing system 220 and stored in the data store 230 and associated with the establishment’s account 236. The establishment’s account 236 has stored in memory 104 various details such as the establishment name and location which can be associated in the memory 104 with the transferred data log record 134. The data log record 134 can be transferred and synchronised with the remote server processing system 220 via one or more communication protocols or mediums such as Bluetooth, Wi-Fi, USB (Universal Serial Bus), etc. The data log record 134 transferred to the server processing system 220 can be received indirectly from one or more other computing device such as the mobile communication device 210 which communicates wirelessly with the kitchen appliance 100. It will be appreciated that the server processing system 220 may be a cloud computing server processing system. In one form, after synchronising the data log record 134 with the establishment account 236, the data log record can be electronically shared with one or more users. For example, the kitchen appliance 100, the computing device 210 or the remote server processing system 220 may generate and send an email indicative of the data log record to one or more parties. The memory 104 of the device sending the email can receive via an input device or have stored in memory one or more email addresses which the email is sent to.

It will be appreciated from the above method 500 that a number of the steps can be performed in various orders.

Whilst sous vide cooking is in progress, the processor 105 can be configured to output, via the output device 106, a most recent first temperature and a most recent second temperature sample based on temperature samples obtained from the first and second temperature sensors 113.

In certain embodiments, when a remaining capacity of the memory 104 is equal to or below an initial threshold amount, the processor 105 is configured to present a warning to transfer at least some of the data log records to a computing device 210, 220 such as a mobile communication device 210 or a cloud server processing system 220. The user can interact with the input device 108 of the kitchen appliance 100 or the computing device 210, 220 to cause the processor 105 of the kitchen appliance 100 to transfer at least some of the plurality of data log records to the computing device 210, 220. The processor 105 is then configured to record, in the memory 104, a sent flag associated with each data log record which were transferred to the computing device 210, 220. In response to the remaining capacity of memory being equal to or below a further threshold amount of free capacity, the processor 105 is configured to delete, in chronological order, at least some of the plurality of data log records stored in the memory 104 having an associated sent flag. In one form, the initial threshold amount is set in memory to 10% (i.e. 10% of the memory 104 is free to store one or more data log records). In one form, the further threshold amount is stored in memory at 2% of the capacity of the memory (i.e. 2% of the memory 104 is free to store one or more data log records). In one form, the processor 105 is configured to delete a portion of the plurality of data records stored in the memory 104 to free up a threshold amount of the memory. The threshold amount of memory which is freed up can be set in memory to 50% (i.e. 50% of the memory is free to stored new data log records). Using this technique, the user is not regularly presented with the warning that the memory is low on free capacity to store data log records.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A kitchen appliance for sous vide cooking, including:
a heater for heating a fluid;
a first temperature sensor for sensing a temperature of a food item contained in a sous vide bag located within the fluid of a vessel;
a second temperature sensor for sensing a temperature of the fluid; and
a controller, operatively connected to the heater and in communication with the first and second temperature sensors, wherein the controller comprises of a memory and a processor configured to:
receive, from the first temperature sensor, one or more first temperature samples indicative of a temperature of the food item;
receive, from the second temperature sensor, one or more second temperature samples indicative of a temperature of the liquid;
control operation of the heater according to the one or more second temperature samples and a target cooking temperature; and
store, in memory in a non-volatile manner, the one or more first temperature samples.

2. The kitchen appliance according to claim 1, further comprising:
an input device, in communication with the processor, to receive user input to selectively enable a data logging mode; and
an output device, in communication with the processor;
wherein the processor is configured to:
receive, from the input device, user input indicative of enablement of a data logging mode of the kitchen appliance; and
output, via the output device, an indication that the kitchen appliance is operating in the data logging mode.

3. The kitchen appliance according to claim 2, wherein the processor is configured to output one or more temperatures based on at least some of the one or more first temperature samples and the one or more second temperature samples.

4. The kitchen appliance according to claim 3, wherein the processor is configured to output, via the output device:
a current food item temperature based on at least some of the one or more first temperature samples; and
a current fluid temperature based on at least some of the one or more second temperature samples.

5. The kitchen appliance according to claim 3 or 4, wherein the processor is configured to output, via the output device, the target fluid temperature.

6. The kitchen appliance according to any one of claims 3 to 5, wherein the processor is configured to:
receive, via the input device, the target fluid temperature; and
record, in the memory, the target fluid temperature.

7. The kitchen appliance according to any one of claims 2 to 6, wherein the processor is configured to:
receive, via the input device, a selection of an operating user of the kitchen appliance for cooking the food item; and
record, in the memory, an association between the operating user and the one or more second temperature samples.

8. The kitchen appliance according to any one of claims 2 to 7, wherein the processor is configured to:
receive, via the input device, a log name; and
record, in the memory, an association between the log name and the one or more second temperature samples.

9. The kitchen appliance according to any one of claims 2 to 8, wherein the processor is configured to:
receive, via the input device, a thickness of the food item; and
record, in the memory, an association between the thickness of the food item with the one or more second temperature samples.

10. The kitchen appliance according to any one of claims 2 to 9, wherein the processor is configured to receive, from the input device, input indicative of a start of a data logging job, wherein in response to receiving the input indicative of the start of a data logging job, the one or more first temperature samples are recorded in the memory.

11. The kitchen appliance according to any one of claims 2 to 10, wherein the processor is configured to receive, from the input device, input indicative of an end of the data logging job, wherein in response to receiving the input indicative of the end of the data logging job, the one or more first temperature samples are no longer recorded in the memory.

12. The kitchen appliance according to claim 2 to 11, wherein the processor is configured to:
receive, via the input device and whilst the food item is being cooked, input indicative of a request for output of at least some of the one or more first temperature samples recorded for the food item; and
retrieve, from memory, and output, via the output device, the one or more first temperature samples recorded for the food item being cooked.

13. The kitchen appliance according to any one of claims 1 to 12, wherein the processor is configured to record, in the memory, temporal data in association with the one or more second temperature samples.

14. The kitchen appliance according to any one of claims 1 to 13, wherein the processor is configured to record in memory a timestamp associated at least one of each first temperature sample.

15. The kitchen appliance according to any one of claims 1 to 14, wherein the memory has stored therein a plurality of data log records, each data log record including one or more first temperature samples recorded for cooking a respective food item, wherein the processor is configured to:
transfer at least some of the plurality of data log records to a computing device;
record, in memory, a sent flag associated with each data log record from the plurality of data log records which were transferred to the computing device; and
in response to the memory having less than a threshold amount of free capacity, delete, in chronological order, at least some of the plurality of data log records having an associated sent flag.

16. The kitchen appliance according to any one of claims 1 to 15, wherein the first temperature sensor is in communication with the processor via a wired medium.

17. The kitchen appliance according to any one of claims 1 to 16, wherein the first temperature sensor is received with a sealable port of the sous vide bag.

18. The kitchen appliance according to any one of claims 1 to 17, wherein the kitchen appliance is one of:
a thermal immersion circulator;
an oven; or
a heating blender.

19. A system including:
the kitchen appliance of claim 1 to 18; and
a mobile communication device configured to receive the one or more first temperature samples recorded in the memory of the controller.

20. The system according to claim 19, wherein the kitchen appliance is configured to wirelessly transfer the one or more first temperature samples to the mobile communication device.

21. The system according to claim 19 or 20, wherein the kitchen appliance is configured to transfer, via the mobile communication device, the one or more first temperature samples to a cloud server processing system.

22. A method performed by a kitchen appliance, the kitchen appliance including a heater for heating a fluid, a first temperature sensor in physical contact with a food item contained in a sous vide bag located within the fluid, a second temperature sensor for sensing the temperature of the fluid, and a controller, operatively connected to the heater and in communication with the first and second temperature sensors, wherein the controller comprises of a memory and a processor, wherein the method includes:
receiving, by the processor from the first temperature sensor, one or more first temperature samples indicative of a temperature of the food item;
receiving, by the processor from the second temperature sensor, one or more second temperature samples indicative of a temperature of the liquid;
controlling, by the processor, operation of the heater according to the one or more second temperature samples and a target cooking temperature; and
storing, by the processor in memory in a non-volatile manner, the one or more first temperature samples.

23. The method according to claim 22, wherein the kitchen appliance further comprises an input device, in communication with the processor, to receive user input to selectively enable a data logging mode, and an output device, in communication with the processor, wherein the method includes:
receiving, by the processor from the input device, user input indicative of enablement of a data logging mode of the kitchen appliance; and
outputting, by the processor via the output device, an indication that the kitchen appliance is operating in the data logging mode.

24. The method according to claim 23, wherein the method includes outputting, by the processor, one or more temperatures based on at least some of the one or more first temperature samples and the one or more second temperature samples.

25. The method according to claim 24, wherein the method includes outputting, by the processor via the output device:
a current food item temperature based on at least some of the one or more first temperature samples; and
a current fluid temperature based on at least some of the one or more second temperature samples.

26. The method according to claim 24 or 25, wherein the method includes the processor outputting, via the output device, the target fluid temperature.

27. The method according to any one of claims 24 to 26, wherein the method includes: receiving, by the processor via the input device, the target fluid temperature; and recording, by the processor in the memory, the target fluid temperature.

28. The method according to any one of claims 23 to 27, wherein the method includes:
receiving, by the processor via the input device, a selection of an operating user of the kitchen appliance for cooking the food item; and
recording, by the processor in the memory, an association between the operating user and the one or more second temperature samples.

29. The method according to any one of claims 23 to 28, wherein the method includes:
receiving, by the processor via the input device, a log name; and
recording, by the processor in the memory, an association between the log name and the one or more second temperature samples.

30. The method according to any one of claims 23 to 29, wherein the method includes:
receiving, by the processor via the input device, a thickness of the food item; and
recording, by the processor in the memory, an association between the thickness of the food item with the one or more second temperature samples.

31. The method according to any one of claims 23 to 30, wherein the method includes receiving, by the processor from the input device, input indicative of a start of a data logging job, wherein in response to receiving the input indicative of the start of a data logging job, the one or more first temperature samples are recorded in the memory.

32. The method according to any one of claims 23 to 31, wherein the method includes receiving, by the processor from the input device, input indicative of an end of the data logging job, wherein in response to receiving the input indicative of the end of the data logging job, the one or more first temperature samples are no longer recorded in the memory.

33. The method according to claim 23 to 32, wherein the method includes:
receiving, by the processor via the input device and whilst the food item is being cooked, input indicative of a request for output of at least some of the one or more first temperature samples recorded for the food item; and
retrieving, by the processor from memory, and outputting, by the processor via the output device, the one or more first temperature samples recorded for the food item being cooked.

34. The method according to any one of claims 22 to 33, wherein the method includes recording, by the processor in the memory, temporal data in association with the one or more second temperature samples.

35. The method according to any one of claims 22 to 34, wherein the method includes recording by the processor in memory a timestamp associated each first temperature sample.

36. The method according to claim 34 or 35, wherein the memory has stored therein a plurality of data log records, each data log record including one or more first temperature samples recorded for cooking a respective food item, wherein the method includes
transferring, by the processor, at least some of the plurality of data log records to a computing device;
recording, by the processor in the memory, a sent flag associated with each data log record from the plurality of data log records which were transferred to the computing device; and
in response to the memory having less than a threshold amount of free capacity, deleting, in chronological order, at least some of the plurality of data log records having an associated sent flag.

37. The method according to any one of claims 22 to 36, wherein the method includes communicating between the first temperature sensor and the processor via a wired medium.

38. The method according to any one of claims 22 to 37, wherein the method includes transferring, by the processor to a mobile communication device, the one or more first temperature samples stored in memory of the controller.

39. The method according to claim 38, wherein the method includes wirelessly transferring, by the processor to the mobile communication device, the one or more first temperature samples.

40. The method according to claim 38 or 39, wherein the method includes transferring, by the processor via the mobile communication device, the one or more first temperature samples to a cloud server processing system.

41. The method according to any one of claims 22 to 40, wherein the method includes placing the first temperature sensor in physical contact with the food item via a sealable port of the sous vide bag.

42. The method according to any one of claims 22 to 41, wherein the kitchen appliance is one of:
a thermal immersion circulator;
an oven; or
a heating blender.

43. One or more computer readable mediums have stored therein or thereon executable instructions, wherein execution of the executable instructions by one or more processors of a kitchen appliance cause the kitchen appliance to perform the method of any one of claims 22 to 42.
